(19) United States
(12) Patent Application Publication
(10) Pub. No.: US 2025/0306828 A1
(43) Pub. Date: Oct. 2, 2025

(54) INFORMATION PROCESSING APPARATUS, SYSTEM, INFORMATION PROCESSING METHOD, AND STORAGE MEDIUM

(71) Applicant: CANON KABUSHIKI KAISHA, Tokyo (JP)

(72) Inventors: SHO MAGARIYAMA, Kanagawa (JP); ARATA MIYAGI, Kanagawa (JP)

(21) Appl. No.: 19/088,588

(22) Filed: Mar. 24, 2025

(30) Foreign Application Priority Data
Mar. 27, 2024 (JP) 2024-051064

(51) Int. Cl. G06F 3/12

(52) U.S. Cl. CPC G06F 3/127; G06F 3/1205; G06F 3/1253; G06F 3/1288

(57) ABSTRACT

A server system configured to communicate with an information processing apparatus is provided. The server system includes a providing unit, a registering unit, and an acquiring unit. The providing unit is configured to provide the information processing apparatus with information for displaying a setting screen on which settings regarding a hot folder are made at the information processing apparatus. The registering unit is configured to, based on an operation received from a user on the setting screen, register information on the hot folder correspondingly together with a setting value associated with the hot folder. The acquiring unit is configured to acquire capability information on an image processing apparatus that is a target. The providing unit provides information for displaying a setting screen of printing according to the capability information acquired by the acquiring unit.

### BACKGROUND

### Field of the Disclosure

Some aspects of embodiments relate to an information processing apparatus, a system, an information processing method, and a non-transitory computer-readable storage medium.

### Description of the Related Art

The following scheme called “hot folder” is known (Japanese Patent Laid-Open No. 2014-219920). A folder has been prepared in a client apparatus such as a PC. In response to a storing of a target file into the folder, the client apparatus performs image processing associated with the folder on the target file. Then, for example, the processed target in the folder is configured as a print job, and the print job is transmitted from the client apparatus to an image forming apparatus such as a printer, and print processing is executed at the printer. With this scheme, the user of the client apparatus is able to give print instructions just by performing a relatively simple operation of storing the target file, which is to be printed, into the hot folder. For example, when a user wants to give print instructions for printing many print target files (a large amount of print data) under the same print settings, the user can give the print instructions under the same print settings by storing these files in a batch into the hot folder. This scheme saves the user the trouble of selecting each printing target file individually and giving print instructions individually by using an application such as a printer driver. In the scheme of a hot folder according to related art, setting information associated with the hot folder is registered and used on a client-apparatus-by-client-apparatus basis. For example, in related art, to register and use a hot folder with which the same setting information is associated on another client apparatus, the user has to perform registration of the setting information from scratch.

### SUMMARY

Print instructions using a hot folder are given based on print settings associated with this hot folder. The present disclosure provides a method that makes it possible to register and use folder setting information in a desirable manner.

Provided by some aspects of embodiments is a server system configured to communicate with an information processing apparatus. The server system includes a providing unit, a registering unit, and an acquiring unit. The providing unit is configured to provide the information processing apparatus with information for displaying a setting screen on which settings regarding a hot folder are made at the information processing apparatus. The registering unit is configured to, based on an operation received from a user on the setting screen, register information on the hot folder correspondingly together with a setting value associated with the hot folder. The acquiring unit is configured to acquire capability information on an image processing apparatus that is a target. The providing unit provides information for displaying a setting screen of printing according to the capability information acquired by the acquiring unit.

Further features of the present disclosure will become apparent from the following description of exemplary embodiments with reference to the attached drawings.

### BRIEF DESCRIPTION OF THE DRAWINGS

FIG. 1 is a configuration diagram of a system according to a certain embodiment.

FIG. 2 is a hardware configuration diagram of an information processing apparatus according to a certain embodiment.

FIG. 3 is a hardware configuration diagram of an image forming apparatus according to a certain embodiment.

FIG. 4 is a software configuration diagram of an information processing apparatus according to a certain embodiment.

FIG. 5 is a software configuration diagram of an image forming apparatus according to a certain embodiment.

FIG. 6 is a software configuration diagram of a cloud service according to a certain embodiment.

FIG. 7 is a diagram illustrating capability information of an image forming apparatus according to a certain embodiment.

FIG. 8 is a diagram illustrating a merchandise template management/creation screen according to a certain embodiment.

FIG. 9 is a diagram illustrating a hot folder management/creation screen according to a certain embodiment.

FIG. 10 is a merchandise template creation flowchart according to a certain embodiment.

FIG. 11 is a merchandise template editing flowchart according to a certain embodiment.

FIG. 12 is a hot folder creation flowchart according to a certain embodiment.

FIG. 13 is a flowchart of a hot folder application according to a certain embodiment.

FIG. 14 is a flowchart of a cloud application according to a certain embodiment.

FIG. 15 is a flowchart of a print job transmitting/receiving unit according to a certain embodiment.

FIG. 16A is a configuration diagram of a job management table according to a certain embodiment illustrating an example of information stored in a job storage unit.

FIG. 16B is a configuration diagram of a job management table according to a certain embodiment illustrating an example of information stored in an image forming apparatus information storage unit.

FIG. 16C is a configuration diagram of a job management table according to a certain embodiment illustrating an example of information stored in a job storage unit.

FIG. 17 is a diagram illustrating an image forming apparatus management/addition screen according to a certain embodiment.

FIG. 18A is an image forming apparatus addition flowchart according to a certain embodiment illustrating a flow of adding an image forming apparatus at an information processing apparatus.

FIG. 18B is an image forming apparatus addition flowchart according to a certain embodiment illustrating a flow of adding an image forming apparatus at a cloud service.

FIG. 19 is a merchandise template updating flowchart at a time of printing according to a second embodiment.

FIG. 20A is a software configuration diagram of an information processing apparatus according to a third embodiment.

FIG. 20B illustrates a hot folder management screen provided by a hot folder application according to a third embodiment.

### DESCRIPTION OF THE EMBODIMENTS

With reference to the accompanying drawings, embodiments for implementation of the present disclosure will now be described. The embodiments described below shall not be construed to limit the present disclosure recited in the appended claims. Not all of the features described in the embodiments necessarily have to be combined for providing solutions proposed in the present disclosure.

### First Embodiment

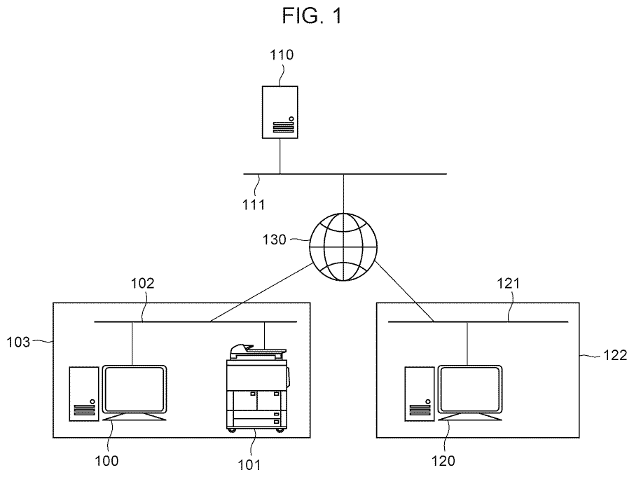

FIG. 1 is a schematic view of an example of the configuration of a cloud printing system according to the present embodiment. An information processing apparatus 100 such as a computer, and an image forming apparatus 101, are connected to the Internet 130 via a LAN (Local Area Network) 102 at a hub X103. At a hub Y122, similarly, an information processing apparatus 120 is connected to the Internet 130 via a LAN 121. A plurality of image forming apparatuses 101 may be installed at each of the hub X103 and the hub Y122. The image forming apparatuses 101 may be of different models from one another. A cloud service 110 is connected to the Internet 130 via a LAN (Local Area Network) 111. The cloud service 110 is provided by a server system comprised of one or more information processing apparatuses. There may be a plurality of cloud services 110. A plurality of cloud services 110 may be combined as one cloud service. The information processing apparatus 100, the information processing apparatus 120, and the image forming apparatus 101 are capable of communicating with the cloud service 110 via the Internet 130.

A user can log into the cloud service 110 from the information processing apparatus 100 to create, edit, and delete a merchandise template used in a hot folder application 400 of the information processing apparatus 100. The term “hot folder” means that setting information is associated with each folder in advance, and, upon storing of a file into a folder, the stored file is processed in accordance with the setting information associated with this folder. The term “merchandise template” means a suite of setting values associated with a folder; specifically, it is assumed herein that this is a group of setting values for giving an instruction for printing. The hot folder application 400 running on the information processing apparatus 100 is capable of downloading a merchandise template that the cloud service 110 has. The hot folder application 400 is capable of creating a hot folder associated with the downloaded merchandise template. The hot folder application 400 transmits a printing file(s) stored in the hot folder and an identifier of the merchandise template to the cloud service 110 as a print job. Based on the merchandise template, the cloud service 110 performs data conversion on the print job received from the hot folder application 400, and transmits the print job to the image forming apparatus 101. The image forming apparatus 101 prints out the print job received from the cloud service 110. The hot folder application 400 may run on the information processing apparatus 120. The cloud service 110 is accessible for use also from the information processing apparatus 120 similarly.

The present embodiment will be described below based on the above architecture taken as an example of a cloud printing system. However, the scope of the present disclosure is not limited thereto. It is sufficient as long as the information processing apparatus 100, the image forming apparatus 101, and the cloud service 110 are connected in such a way as to be able to communicate with one another via a network. The network may be a wireless network or a wired network. The image forming apparatus 101 suffices to have a print function, and thus may be a single-function apparatus that has a print function only or an MFP (Multi-Function Peripheral) that has either one or both of a scan function and a fax function in addition to a print function.

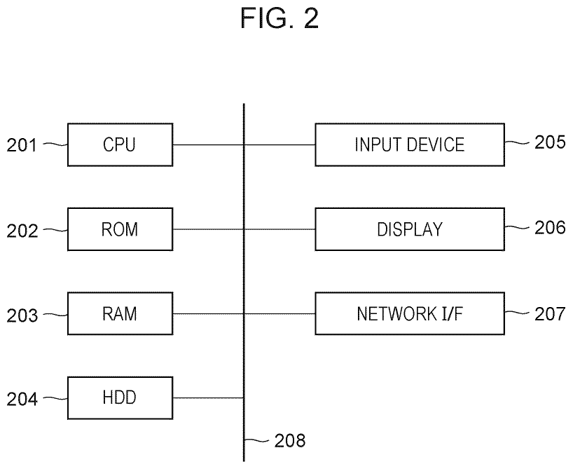

FIG. 2 is a diagram illustrating an example of the hardware configuration of the information processing apparatus 100, 120 according to the present embodiment.

The information processing apparatus 100, 120 includes a CPU 201, a ROM 202, a RAM 203, an HDD 204, an input device 205, a display 206, and a network I/F 207. All of these components are connected to a bus 208.

The CPU 201 reads out a control program stored in the ROM 202 or the HDD (Hard Disk Drive) 204, and performs various kinds of control processing. The RAM 203 is used as a temporary storage area such as a main memory of the CPU 201, a work area thereof, and the like. The HDD 204 stores image data and various programs. In place of the HDD or in combination with the HDD, any other kind of storage device such as an SSD (Solid-State Drive) may be provided.

The input device 205 is an instruction input unit used for giving a control command instruction and a text input instruction to an application that will be described later, and includes a keyboard, a pointing device, and the like.

The display 206 is an output device functioning as a display unit, and displays the command inputted from the input device 205, the status of the application that will be described later, and the like.

The network I/F 207 connects the information processing apparatus 100, 120 to a network (LAN, intranet, Internet, etc.). By using the network I/F 207, the information processing apparatus 100, 120 transmits various kinds of information to, and receives various kinds of information from, other apparatuses residing on the network.

The hardware configuration of the cloud service 110 is the same as or similar to the hardware configuration of the information processing apparatus 100 illustrated in FIG. 2.

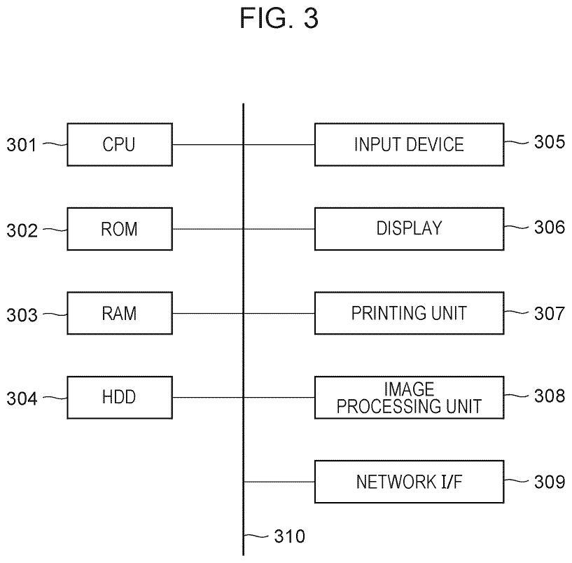

FIG. 3 is a diagram illustrating an example of the hardware configuration of the image forming apparatus 101 according to the present embodiment. The image forming apparatus 101 includes a CPU 301, a ROM 302, a RAM 303, an HDD 304, an input device 305, a display 306, a printing unit 307, an image processing unit 308, and a network I/F 309. All of these components are connected to a bus 310.

The CPU 301 reads out a control program stored in the ROM 302 or the HDD (Hard Disk Drive) 304, and performs various kinds of control processing. The RAM 303 is used as a temporary storage area such as a main memory of the CPU 301, a work area thereof, and the like. The HDD 304 stores image data and various programs. In place of the HDD or in combination with the HDD, any other kind of storage device such as an SSD (Solid-State Drive) may be provided.

The input device 305 is an instruction input unit used for giving a control command instruction, and includes a touch panel stacked on the display 306. The display 306 displays a UI for operating the image forming apparatus 101, and image data. The image processing unit 308 performs correction processing, modification processing, and editing processing on input image data. The printing unit 307 performs printing of the data processed by the image processing unit 308. The network I/F 309 connects the information processing apparatus 100, 120 to a network (LAN, intranet, Internet, etc.).

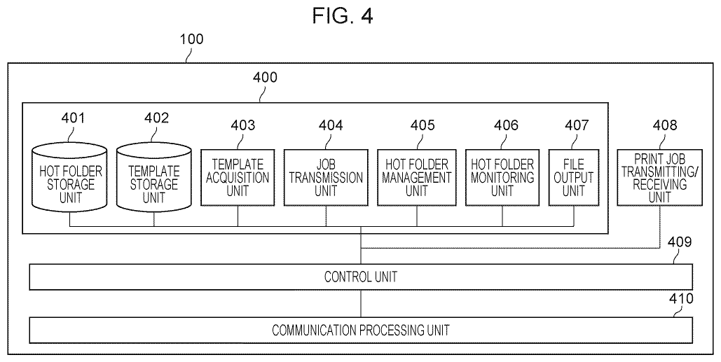

FIG. 4 is a software configuration diagram of the information processing apparatus 100, 120 according to the present embodiment. The illustrated components are realized by running programs stored in the ROM 202, the HDD, or the like of the information processing apparatus 100, 120 by the CPU 201. The same reference numerals are assigned to the same components as those described already, and an explanation of them will be omitted. The configuration illustrated in FIG. 4 is a functional configuration realized by running programs by a computer. Implementation does not necessarily have to be exactly in accordance with FIG. 4. There are possible variations in configuration: for example, a plurality of functional blocks may be merged, or a part of a certain functional block or a part of some functional blocks in FIG. 4 may be included into another functional block or other functional blocks.

The reference numeral 400 denotes a hot folder application that realizes a hot folder function on the information processing apparatus 100. The reference numeral 401 denotes a hot folder storage unit that stores information on hot folders managed by the hot folder application 400. The reference numeral 402 denotes a template storage unit that stores merchandise templates used in the hot folder application 400. The reference numeral 403 denotes a template acquisition unit that acquires a merchandise template from the cloud service 110.

The reference numeral 404 denotes a job transmission unit that transmits a print job from a hot folder to the cloud service. The reference numeral 405 denotes a hot folder management unit that manages information on each hot folder and manages a merchandise template. The reference numeral 406 denotes a hot folder monitoring unit that monitors whether a printing file is placed into a hot folder. The reference numeral 407 denotes a file output unit that outputs a printing file having been subjected to imposition by the cloud service 110 to a hot folder. The reference numeral 408 denotes a print job transmitting/receiving unit that receives print data having been subjected to imposition by the cloud service 110 and transmits it to the image forming apparatus 101. The print job transmitting/receiving unit 408 may be provided in the information processing apparatus 120 or in any other information processing apparatus; however, it is preferable if the print job transmitting/receiving unit 408 is located within the same network as one to which the image forming apparatus 101 belongs. The reference numeral 409 denotes a control unit that controls processing and communication with the components 401 to 408.

The reference numeral 410 denotes a communication processing unit that performs processing for communication between the information processing apparatus 100 and another apparatus such as the image processing apparatus.

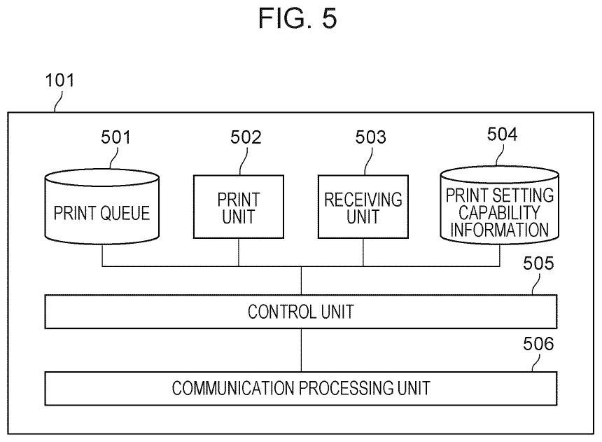

FIG. 5 is a diagram illustrating an example of the software configuration of the image forming apparatus 101 according to the present embodiment.

The illustrated components are realized by running programs stored in the ROM 302 of the image forming apparatus 101 by the CPU 301.

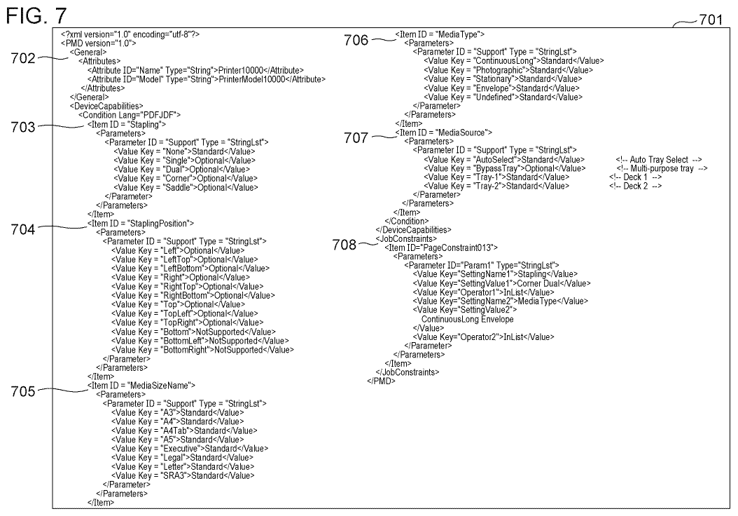

A print queue 501 is capable of queueing and storing a print job received by a receiving unit 503. A print file such as a PDF and a print setting file such as a JDF are included in a print job. A print control unit 502 performs control to read out the print file such as a PDF and the print setting file such as a JDF that is included in the print job stored in the print queue 501, to perform rendering, image processing, and the like, and to transmit it to the printing unit 307. The receiving unit 503 controls the network I/F 309, and performs control to store the received print job into the print queue 501. A print setting capability information 504 is a database that represents the print capability of the image forming apparatus 101. The print capability will be described in detail later with reference to FIG. 7.

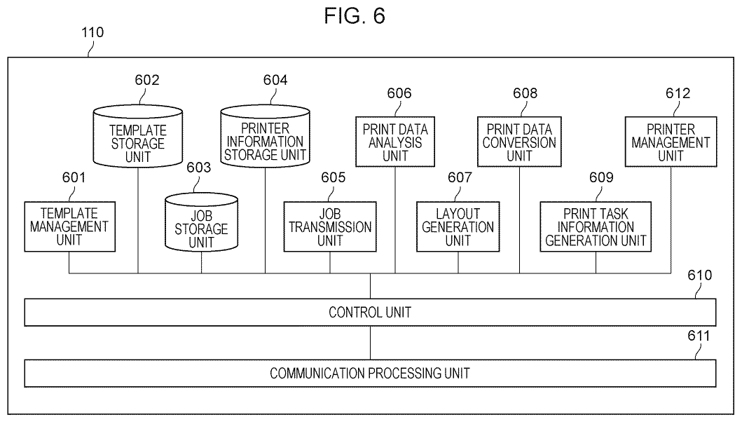

FIG. 6 is a diagram illustrating an example of the software configuration of the cloud service 110 according to the present embodiment. The illustrated components are realized by loading programs stored in the HDD 204 of one or more image forming apparatuses of the cloud service 110 into the RAM 203 and then by running the loaded programs by the CPU 201.

A template management unit 601 is a program that performs reading, writing, and updating of a template storage unit 602. The template storage unit 602 is a database that stores merchandise templates. A job storage unit 603 is a database that stores job information. An image forming apparatus information storage unit 604 is a database that stores information on capabilities of image processing apparatuses supported by this cloud service. A job transmission unit 605 is a program that performs control to enable reading of a job stored in the job storage unit 603 from the information processing apparatus 100.

A print data analysis unit 606 is a program that performs preflight to check whether the PDF file inputted to the cloud service is suited for printing. A layout generation unit 607 is a program that specifies imposition processing. A print data conversion unit 608 is a program that converts the PDF file inputted to the cloud service into a PDF file to be transmitted to the printing apparatus. A print task information generation unit 609 is a program that generates a JDF for specifying printing to the printing apparatus. A control unit 610 is a program for providing a predetermined service by combining programs of the cloud service 110. A communication control unit 611 is capable of controlling HTTP protocol communication to communicate with another service of the cloud, the information processing apparatus 100, the information processing apparatus 120, and the image forming apparatus 101. An image forming apparatus management unit 612 is a program that processes a request for registration of the image forming apparatus 101 from the information processing apparatus 100.

FIG. 7 is a diagram illustrating capability information on an image forming apparatus according to the present embodiment. For example, capability information is possessed by an image forming apparatus and is used by the hot folder application 400 and the cloud service 110.

A capability information file 701 is a file that shows the capability information of the image forming apparatus 101, and is assumed to be an XML file in this example.

General information 702 (General) includes an image forming apparatus name (Name) and a model name (Model).

Staple capability 703 (Stapling) represents a staple function that the image forming apparatus 101 has. In the present embodiment, there are the following setting values regarding stapling: no stapling is performed (None); single stapling (Single); dual stapling (Dual); corner stapling (Corner); and saddle stapling (Saddle). Staple position information 704 is designation information of staple position that can be designated to the image forming apparatus 101. Left position (Left), left top position (LeftTop), left bottom position (LeftBottom), right position (Right), right top position (RightTop), and right bottom position (RightBottom) can be designated. This information indicates that, in addition to them, top position, top left position, top right position, bottom position, bottom left position, and bottom right position are also available.

Media size name 705 shows the names of sheet sizes supported by the image forming apparatus 101. In the present embodiment, A3, A4, A4Tab, A5, Executive, Legal, Letter, and SRA3 can be designated. Media type 706 (MediaType) shows the types of media supported by the image forming apparatus 101. In the present embodiment, ContinuousLong, Photographic, Stationary, Envelope, and Undefined can be designated. Media source 707 shows information on sheet feeding ports supported by the image forming apparatus 101. In the present embodiment, AutoSelect, BypassTray, Tray-1, and Tray-2 can be designated.

Constraint information 708 shows a combination of job setting values that the image forming apparatus 101 cannot accept. In the present embodiment, a combination of designation of dual stapling (Dual) or corner stapling (Corner) in the staple function and designation of continuous sheet (ContinuousLong) or envelope (Envelope) in the media type is indicated to be non-executable. A plurality of combinations can be described in the constraint information; accordingly, various constraint conditions can be defined besides this example.

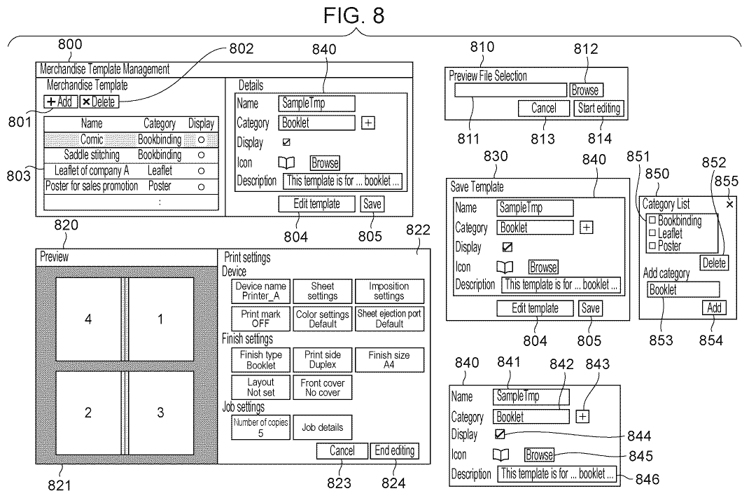

FIG. 8 illustrates a management screen for a merchandise template provided by the cloud service 110 according to the present embodiment. For example, this screen is displayed on a Web browser of the information processing apparatus 100 upon the information processing apparatus 100 accessing the cloud service 110. Each screen illustrated in FIG. 8 is an example of a screen for creating a merchandise template. Implementation does not necessarily have to be exactly in accordance with FIG. 8. The information processing apparatus 100 may use any means other than the browser instead to display the screens provided by the cloud service 110.

The reference numeral 800 denotes a merchandise template management screen. The reference numeral 801 denotes a merchandise template addition button. When this button is pressed, a preview file selection screen 810 opens. The reference numeral 802 denotes a merchandise template deletion button. When this button is pressed, the merchandise template selected from a merchandise template list 803 is deleted from the template storage unit 602. The reference numeral 803 denotes a table showing the merchandise template list. The merchandise templates stored in the template storage unit 602 are displayed in this table in a list format. A login screen for logging in to the service may be presented before displaying the merchandise template management screen 800, and the merchandise template list corresponding to the login user may be displayed.

The user is able to manage and use the user's own-registered merchandise template, irrespective of the apparatus that the user uses. The reference numeral 804 denotes a merchandise template editing button. This button is for editing the merchandise template selected from the merchandise template list 803. When this button is pressed, a merchandise template print setting screen 820 opens. The reference numeral 805 denotes a merchandise template save button.

When this button is pressed, the merchandise template is stored or updated into the template storage unit 602 under the current print settings and the detail settings.

The reference numeral 840 denotes a merchandise template detail setting value input section. This is an area where detail setting values of the merchandise template selected from the merchandise template list 803 are inputted. A detailed explanation will be given later when explaining 841 to 846.

The reference numeral 810 denotes a screen for selecting a file for preview of the merchandise template. On this screen, a file to be used for preview screen display that will be described later is selected. The reference numeral 811 denotes a file path input field for the preview file. The reference numeral 812 denotes a preview file reference button. When this button is pressed, a file selection dialog (explorer) opens, and the file path of the selected file is inputted into the file path input field 811. The reference numeral 813 denotes a button for canceling the preview file selection. When this button is pressed, the preview file selection screen 810 closes. The reference numeral 814 denotes a merchandise template editing start button. When this button is pressed, the merchandise template print setting screen 820 opens, and the preview file selection screen 810 closes.

The reference numeral 820 denotes a print setting screen for performing the print setting of the merchandise template. The reference numeral 821 denotes a preview display section for checking an image of print data when a print setting change is made. Preview display of print data is performed using the file that is identified on the basis of the information inputted into the file path input field 811. The reference numeral 822 denotes a print setting section for changing print settings. In this section, the image forming apparatus 101 that acquires print settings is selected. In addition, print settings such as sheet size are changed. The cloud service 110 acquires print settings that can be processed by the image forming apparatus selected in a “device name” box, and sets print setting values desired by the user from the print settings. The reference numeral 823 denotes a button for canceling the merchandise template print settings. When this button is pressed, the merchandise template print setting screen 820 closes. The reference numeral 824 denotes a button for ending the editing of the merchandise template print settings. When this button is pressed, the merchandise template print setting screen 820 closes, and a merchandise template setting value input screen 830 is displayed.

The reference numeral 830 denotes the merchandise template setting value input screen that has the merchandise template detail setting value input section 840 where template-related information can be inputted. The merchandise template setting value input screen 830 further includes the merchandise template editing button 804 for opening the merchandise template print setting screen 820 and the merchandise template save button 805 for saving the merchandise template having been set.

The merchandise template detail setting value input section 840 will now be described. The merchandise template detail setting value input section 840 included in the merchandise template management screen 800 and the merchandise template detail setting value input section 840 included in the merchandise template setting value input screen 830 are assumed to be identical to each other. The reference numeral 841 denotes a merchandise template name input field. The reference numeral 842 denotes a category selection field. A selection can be made from a pull-down list of merchandise template categories (bookbinding, leaflet, and the like). The reference numeral 843 denotes a category editing button. When the category editing button 843 is pressed, a category editing screen 850 opens. The reference numeral 844 denotes a display checkbox. Unchecking this checkbox makes it impossible to acquire the applicable merchandise template on the hot folder application 400. The reference numeral 845 denotes an icon selection button. When this button is pressed, a file selection dialog opens, and the selected image file is set as the icon of the merchandise template. The selection may be made from among icons having been determined in advance at the cloud service 110. The reference numeral 846 denotes a description input field. The user inputs and sets a description of this merchandise template.

The category editing screen 850 will now be described. The reference numeral 851 denotes a category list display section. The reference numeral 852 denotes a category deletion button. When this button is pressed, the category selected in the category list display section 851 is deleted. The reference numeral 853 denotes a category addition name input field. The reference numeral 854 denotes a category addition button. When this button is pressed, the category with the category name inputted in the category addition name input field 853 is added into the list. The reference numeral 855 denotes a close button. When this button is pressed, the category editing screen 850 closes.

Data of the merchandise template created here, the category, and the uploaded icon are stored into the template storage unit 602.

Also when the setting values of the merchandise template detail setting value input section 840 are changed on the merchandise template management screen 800, it is possible to save this setting change by pressing the merchandise template save button 805. The file selection on the preview file selection screen 810 may be performed in a manner of selecting a preview file pre-stored in the template storage unit 602.

By means of the screens described above, it is possible to create and edit a merchandise template by using the cloud service 110 via the user interface of the information processing apparatus 100. The creation and editing of the merchandise template can be performed also from another information processing apparatus.

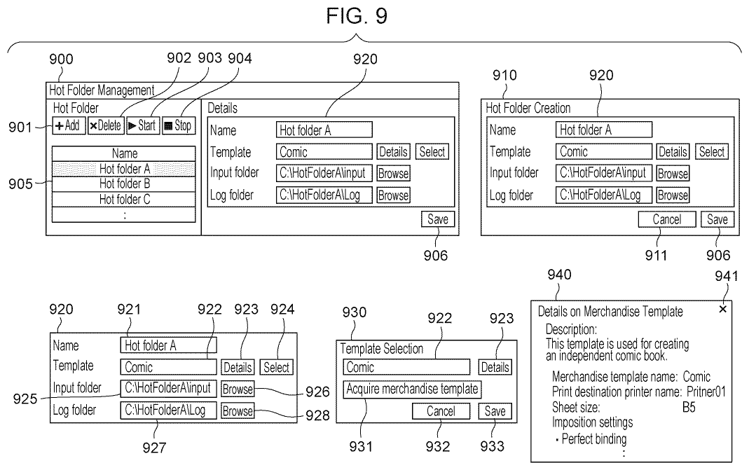

FIG. 9 illustrates a hot folder management screen provided by the hot folder application 400 according to the present embodiment. This screen is, for example, displayed on the browser of the information processing apparatus 100. Implementation of each screen illustrated in FIG. 9 does not necessarily have to be exactly in accordance with FIG. 9, and it is sufficient as long as a hot folder can be created with the selection of a merchandise template. The screen may be displayed using any means other than the browser instead.

For example, the following configuration may be adopted: screen information of screens described below is pre-stored, and the information processing apparatus 100 accesses the cloud service 110 to acquire information when necessary and perform screen display.

The reference numeral 900 denotes a hot folder management screen. The reference numeral 901 denotes a hot folder addition button. When this button is pressed, a hot folder creation screen 910 opens. The reference numeral 902 denotes a hot folder deletion button. When this button is pressed, the hot folder selected from the hot folder list 905 is deleted from the hot folder storage unit 401. The reference numeral 903 denotes a hot folder monitoring start button.

When this button is pressed, the monitoring of the hot folder selected from the hot folder list 905 is started. The reference numeral 904 denotes a hot folder monitoring stop button. When this button is pressed, the monitoring of the hot folder selected from the hot folder list 905 is stopped. The reference numeral 905 denotes the hot folder list. The list of hot holders is acquired from the hot folder storage unit 401 and is displayed. The reference numeral 920 denotes a hot folder detail setting value input section. A detailed explanation will be given later when explaining 921 to 928. The reference numeral 906 denotes a hot folder save button. When this button is pressed, the hot folder is stored or updated into the hot folder storage unit 401 under the current detail settings and the merchandise template.

The reference numeral 910 denotes a hot folder creation screen. The reference numeral 911 denotes a button for canceling hot folder creation. When this button is pressed, the hot folder creation screen 910 closes. The hot folder creation screen 910 further includes the hot folder detail setting value input section 920 and a hot folder save button 906.

The hot folder detail setting value input section 920 will now be described. The reference numeral 921 denotes a hot folder name input field. The reference numeral 922 denotes a merchandise template selection field. The reference numeral 923 denotes a merchandise template detail button. When this button is pressed, a merchandise template detail screen 940 opens. The reference numeral 924 denotes a merchandise template selection button. When this button is pressed, a merchandise template selection screen 930 opens. The reference numeral 925 denotes an input folder input field. The folder set in this field is monitored by a hot folder monitoring unit 406. The reference numeral 926 denotes an input folder reference button. When this button is pressed, a file selection dialog opens, and the path of the selected folder is inputted into an input folder input field 925. The reference numeral 927 denotes a log folder input field. The folder designated in this field is set as a destination to which a log of processing regarding the hot folder is outputted. The reference numeral 928 denotes a log folder reference button. When this button is pressed, a file selection dialog opens, and the path of the selected folder is inputted into the log folder input field 927.

The reference numeral 930 denotes a merchandise template selection screen. The reference numeral 931 denotes a merchandise template acquisition button. When this button is pressed, a request for acquiring all of merchandise templates that the cloud service 110 has from the cloud service 110 is made, and synchronization between the merchandise templates of the template storage unit 602 and the merchandise templates of the template storage unit 402 is performed. A login configuration may be provided in the hot folder application 400, and a list of merchandise templates corresponding to the login user may be acquired. The user selects the merchandise template of the user's choice from the list of merchandise templates acquired here. The reference numeral 932 denotes a button for canceling the merchandise template selection. When this button is pressed, the merchandise template selection screen 930 closes.

The reference numeral 933 denotes a button for saving the selected merchandise template. When this button is pressed, the merchandise template that is currently selected is set as the merchandise template that is to be applied to the hot folder, and the merchandise template selection screen 930 closes. That is, on this screen, it is possible to associate one hot folder with one merchandise template registered in the cloud service 110.

The reference numeral 940 denotes the merchandise template detail screen. Detail information on the merchandise template selected in the merchandise template selection field 922 is displayed. The information that is displayed is the data set in merchandise template description and the print settings of the merchandise template. Other information besides them may be additionally displayed. The reference numeral 941 denotes a close button. When this button is pressed, the merchandise template detail screen 940 closes.

This screen enables creation of a hot folder by using the hot folder application 400 via the user interface of the information processing apparatus 100. Moreover, it is possible to acquire a merchandise template 1403 from the cloud service 110 and apply it to the created hot folder. That is, it is possible to associate information on the hot folder that the information processing apparatus has locally with information on the hot folder that the cloud service 110 has.

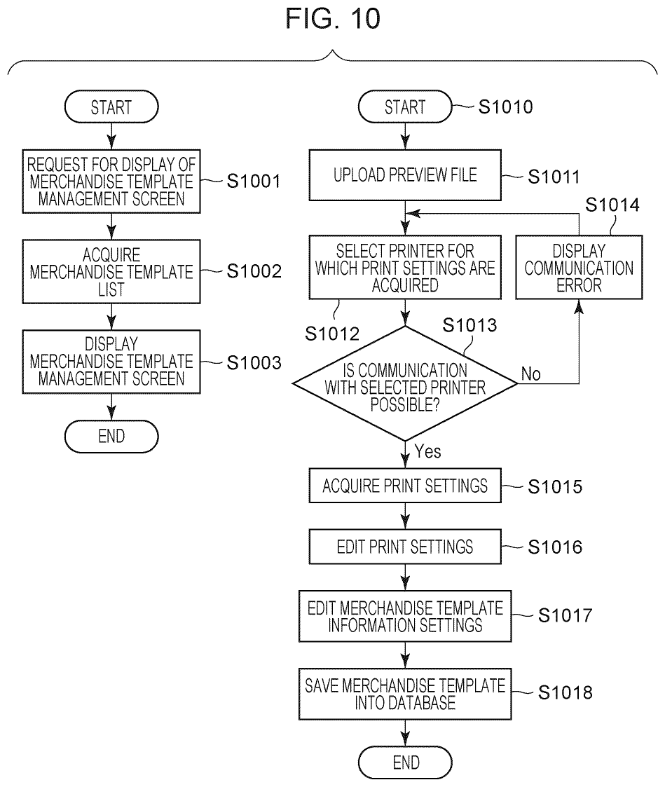

FIG. 10 is a diagram illustrating a flow of displaying the merchandise template management screen 800 at the cloud service 110 and a flow of creating a merchandise template. The processing described below is performed by the CPU 201 of the cloud service 110. Implementation of the processing illustrated in FIG. 10 does not necessarily have to be exactly in accordance with FIG. 10, and it is sufficient as long as a merchandise template can be created. The processing illustrated in this flowchart is initiated when, for example, a request for displaying the merchandise template management screen 800 is made to the cloud service 110 as a result of the user's launching the hot folder application 400 and selecting a predetermined button.

In S1001, the cloud service 110 makes a request for displaying the merchandise template management screen 800 to the template management unit 601.

In S1002, the template management unit 601 makes a request for merchandise template information to the template storage unit 602 and acquires it therefrom.

In S1003, the template management unit 601 provides the merchandise template management screen 800 including a list of the acquired merchandise templates.

In S1010, triggered by the user's pressing the merchandise template addition button 801, the template management unit 601 starts merchandise template creation processing.

In S1011, the template management unit 601 uploads the preview file selected by the user on the preview file selection screen 810 to the cloud service 110.

In S1012, the template management unit 601 receives a user operation in the print setting section 822 and selects the image forming apparatus 101.

In S1013, the template management unit 601 determines whether or not it is possible to perform communication with the image forming apparatus 101 selected in S1012. For the purpose of this determination, a communicability check request about interaction with the image forming apparatus 101 is transmitted from the template management unit 601 to the print job transmitting/receiving unit 408 of the information processing apparatus 100. The print job transmitting/receiving unit 408 conducts a check of the image forming apparatus 101 about the communicability by using a network command, and responds to the template management unit 601 about whether communication is possible or impossible. The process proceeds to S1015 in a case where the communication is possible. The process proceeds to S1014 in a case where the communication is impossible. It is assumed that image forming apparatus information has been registered in the cloud service 110 by the user in advance.

In S1014, the template management unit 601 displays a communication error, and the process returns to S1012.

In S1015, the template management unit 601 acquires the capability information file 701 from the image forming apparatus 101, and reflects selectable print settings into the print setting section 822.

In S1016, the template management unit 601 stores the print setting values set by the user in the print setting section 822. The setting values mentioned here include values of, for example, a paper setting, an imposition setting, a color setting, and a number-of-copies setting.

In S1017, the template management unit 601 stores the setting values of the merchandise template that the user inputted in the merchandise template detail setting value input section 840.

In S1018, based on the user's pressing the merchandise template save button 805, the template management unit 601 stores the created merchandise template 1409 together with the identifier into the template storage unit 602.

Through the processing illustrated in this flowchart, the user is able to register the merchandise template into the cloud service 110. This registration work can be performed from any of the information processing apparatuses.

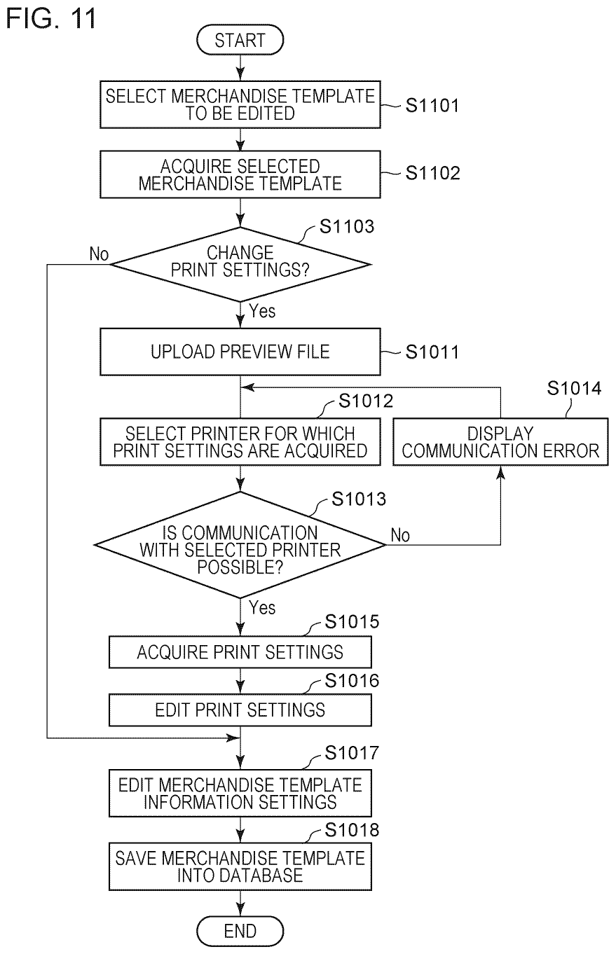

FIG. 11 is a diagram illustrating a merchandise template updating flow executed at the cloud service 110.

The processing described below is performed by the CPU 201 of the cloud service 110. Implementation of the processing illustrated in FIG. 11 does not necessarily have to be exactly in accordance with FIG. 11, and it is sufficient as long as the merchandise template can be updated.

In S1101, the template management unit 601 identifies the merchandise template selected from the merchandise template list 803 by the user.

In S1102, the template management unit 601 acquires information on the merchandise template identified in S1101 and reflects the current setting values into the merchandise template detail setting value input section 840.

In S1103, the template management unit 601 advances the process to S1011 in a case where it is determined that the user presses the merchandise template editing button 804, that is, in a case where it is determined that the print settings are changed. The process proceeds to S1017 in a case where it is determined that the merchandise template editing button 804 is not pressed, for example, in a case where the user edits only the items included in the merchandise template detail setting value input section 840.

The processing in and after S1011 is the same as that of FIG. 10; therefore, the same reference numerals are assigned thereto, and an explanation thereof will be omitted.

Through the processing illustrated in this flowchart, the user is able to edit the merchandise template 1409 managed by the cloud service 110 from any of the client apparatuses at any time.

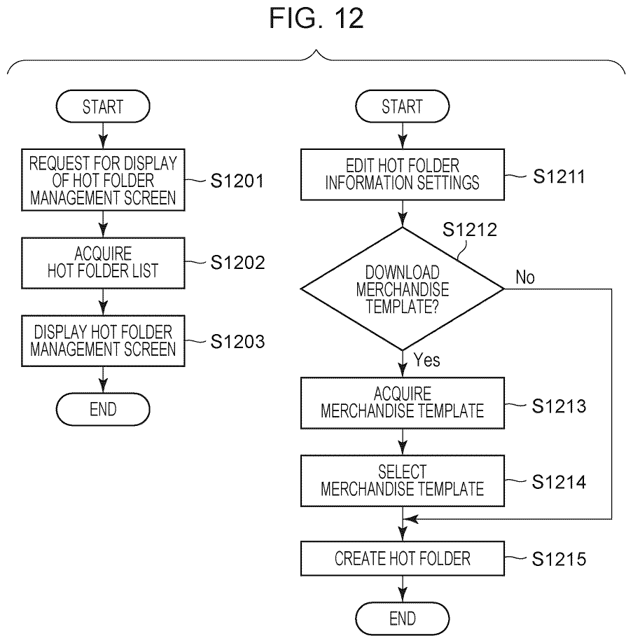

FIG. 12 is a diagram illustrating a flow of displaying the hot folder management screen 900 at the hot folder application 400 and a hot folder creation flow. The processing described below is performed by the CPU 201 of the information processing apparatus 100. Implementation of the processing illustrated in FIG. 12 does not necessarily have to be exactly in accordance with FIG. 12, and it is sufficient as long as a hot folder can be created. The processing illustrated in this flowchart is initiated when, for example, a request for displaying the hot folder management screen 900 is made as a result of the user's launching the hot folder application 400 and selecting a predetermined button.

In S1201, the information processing apparatus 100 issues a request from the user for displaying the hot folder management screen 900 to the hot folder management unit 405.

In S1202, the hot folder management unit 405 makes a request for hot folder information to, and acquires this information from, the hot folder storage unit 401.

In S1203, the hot folder management unit 405 displays the acquired list of the hot folders on the hot folder management screen 900.

In S1211, the hot folder management unit 405 stores the setting values of the merchandise template inputted by the user in the hot folder detail setting value input section 920.

In S1212, the hot folder management unit 405 determines whether the user presses the merchandise template acquisition button 931. The process proceeds to S1213 in a case where the merchandise template acquisition button 931 is pressed. The process proceeds to S1215 in a case where the cancel button 932 or the save button 933 is pressed.

In S1213, the hot folder management unit 405 makes a request for information on the merchandise template to the cloud service 110 and stores the information on the merchandise template acquired on the basis of the request into the template storage unit 402.

In S1214, the hot folder management unit 405 selects, and stores, the merchandise template selected by the user in the merchandise template selection field 922.

In S1215, triggered by the user's pressing the save button 906, the hot folder management unit 405 creates a hot folder according to the setting values set in the hot folder detail setting value input section 920, and stores it into the hot folder storage unit 401. In this step, the identifier of the merchandise template registered in the cloud service 110 is also stored.

Through the processing illustrated in this flowchart, the hot folder application 400 can acquire the merchandise template 1403 from the cloud service 110 and apply it to the hot folder created by the own apparatus. By selecting the merchandise template of the user's choice from among the merchandise templates that are under unified management by the cloud service 110, the user is able to use the merchandise template from the information processing apparatus of the user.

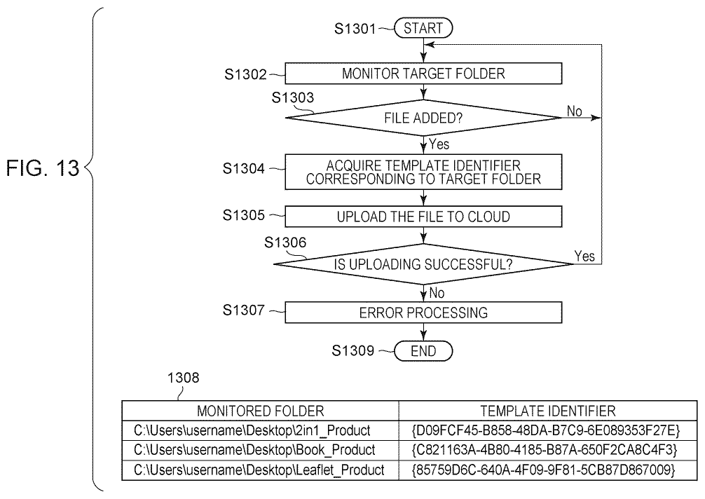

FIG. 13 is a flowchart illustrating a flow of processing performed by the hot folder application 400 according to the present embodiment. Specifically, the hot folder application 400 monitors the folder that is the target, and the illustrated processing is performed when a file is stored into this folder. The hot folder application 400 is an application that runs on the information processing apparatus 100, and is executed by the CPU 201 of the information processing apparatus 100.

In step S1301, the hot folder application 400 is launched to start processing. Then, the process proceeds to step S1302.

In step S1302, the CPU 201 monitors the folder that is the target of hot folder monitoring for detecting a storing of a file. Information on the folder to be monitored is described in a hot folder setting file 1308. Following step S1302, the process proceeds to step S1303.

In step S1303, the CPU 201 determines whether there is a storing of a file into the folder that is the target of hot folder monitoring or not. Based on the extension of the stored file, it is determined whether the type of this file is the processing target type or not. In the present embodiment, the file type that is the target of processing is assumed to be PDF, and its extension is assumed to be “.pdf”. If there is the stored file, the process proceeds to step S1304. If not, the process loops back to step S1302.

In step S1304, the CPU 201 acquires, from the hot folder setting file 1308, the template identifier corresponding to the folder into which there is the storing of the file. For example, in a case where the file has been added into the folder identified by C: ¥Users¥username¥Desktop¥Book_product, the template identifier is {C821163A-4B80-4185-B87A-650F2CA8C4F3}. Upon completion of step S1304, the process proceeds to step S1305. Through the hot folder registration processing described earlier, the hot folder application 400 retains information on hot folders in the hot folder application 400 in memory in association with information on merchandise templates of the cloud service 110.

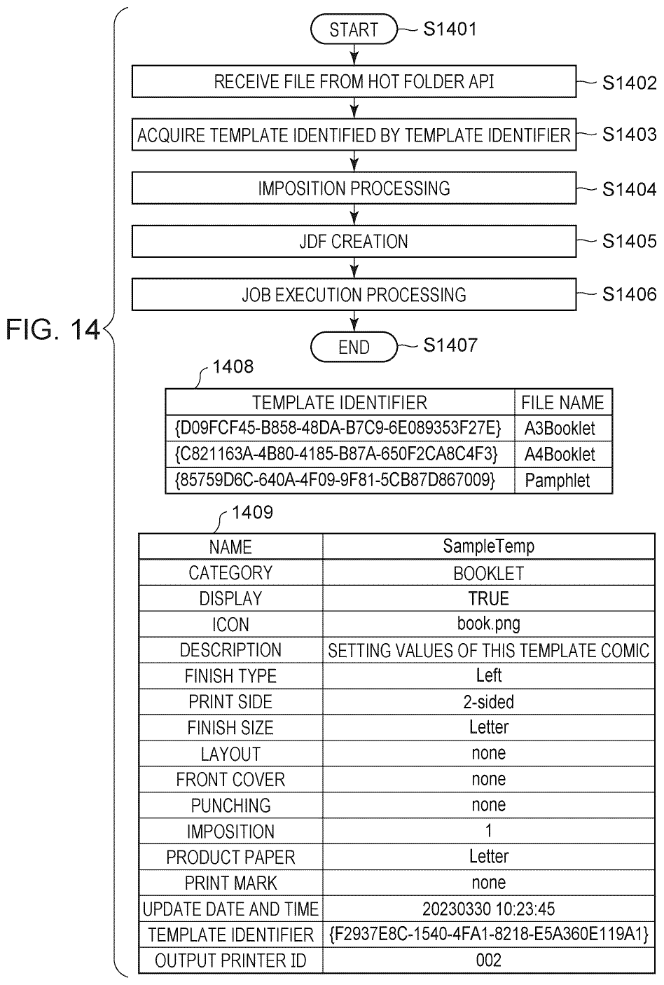

In step S1305, the CPU 201 uploads the PDF file together with the template identifier corresponding to the folder to the cloud service 110. The upload destination URL and the access key are pre-stored in the hot folder application 400. That is, it is assumed that the URL information and the access key that are needed for accessing the cloud service 110 have been set in the hot folder application 400 in advance. The HTTP POST method is used for the uploading. This step corresponds to step S1402 of FIG. 14. The cloud service 110 can receive, in step S1402, the information transmitted by the CPU 201 of the information processing apparatus 100 in this step. The cloud service 110 has a Web API for accepting the uploading. Upon completion of step S1305, the process proceeds to step S1306.

In step S1306, it is determined whether the uploading executed in step S1305 is successful or not. The determination is performed based on whether a POST method response to the uploading performed in step S1305 is 200 (success) or not. A Web API for success/failure confirmation may be used instead of a POST method response. Upon confirmation of successful uploading, the process returns to step S1302 to be ready for the next file uploading. In a case where the uploading is not successful, the process proceeds to step S1307.

In step S1307, the CPU 201 notifies the user of the occurrence of an error though screen display. Upon completion of step S1307, the application processing is terminated (S1309), and the process returns to S1301 through a reboot.

According to this flowchart, when the target file is stored into the monitored folder, the hot folder application 400 can upload the target file together with the template identifier to the cloud service 110.

FIG. 14 is a flowchart for a cloud application according to the present embodiment. The cloud application is executed by the CPU 201 of the cloud service 110.

Upon starting of the service of the cloud application, the CPU 201 starts processing execution from step S1401. This service is launched when triggered by an access made to the Web API configured for PDF file reception and template identifier reception.

Upon completion of start processing in step S1401, the process proceeds to step S1402.

In step S1402, the CPU 201 receives the PDF file and the template identifier from the hot folder API. This step corresponds to step S1305 of FIG. 13. The PDF file and the template identifier sent from the CPU 201 of the information processing apparatus 100 by the hot folder application 400 can be received in this step. The CPU 201 stores the PDF file and the template identifier into the job storage unit 603. Following step S1402, the process proceeds to step S1403.

In S1403, the CPU 201 acquires a template from the template storage unit 602 with the use of the template identifier stored in the job storage unit 603 as a key. The reference numeral 1408 denotes a table for conversion from template identifiers to template file names. In the illustrated example, it is possible to acquire a file name A4Booklet from the template identifier {C821163A-4B80-4185-B87A-650F2CA8C4F3}. The CPU 201 can acquire the merchandise template 1409 from the template storage unit 602 by designating the file name A4Booklet.

The merchandise template 1409 represents a merchandise template structure. This merchandise template has items of “name”, “category”, “display”, “icon”, and “description”. “Name” (Sample Temp) is the display name of the merchandise template, and corresponds to the data inputted in the merchandise template name input field 841. “Category” (booklet) corresponds to the data inputted in the category selection field 842. “Display” corresponds to the data inputted in the display checkbox 844. “Icon” corresponds to the data inputted by means of the icon selection button 845. The merchandise template further includes various print setting values set in the print setting section 822 such as finish type, print side, finish size, layout, cover, punching, imposition, product paper, and print mark. “Update date and time” includes the date and time of the last update of the merchandise template. The merchandise template further includes “template identifier” and “output destination printer ID”. The group of setting values included in the merchandise template are not limited to those described here, and may include various print conditions reflected onto the printing apparatus. Following step S1403, the process proceeds to step S1404.

In step S1404, the CPU 201 performs imposition processing of the PDF file stored in the job storage unit 603 in accordance with the merchandise template 1409. The imposition processing is performed using the layout generation unit 607. Examples of the imposition processing include 2-up print layout processing and bookbinding print layout processing. Upon completion of the imposition processing for image forming in step S1404, the process proceeds to step S1405 next.

In step S1405, the CPU 201 performs JDF creation processing. A print JDF is created using the print task information generation unit 609. In the present embodiment, the JDF is created with designation of A4, plain paper, and saddle stitching. Other necessary items may be designated. Following step S1405, the process proceeds to step S1406.

In step S1406, the CPU 201 performs job execution processing. In this step, the print data conversion unit 608 performs conversion into print PDF data by using the imposition processing result generated in step S1404. In addition, processing for job transmission to the printer identified by the printer ID stored in the merchandise template 1409 is performed using the job transmission unit 605. Following step S1406, the process proceeds to step S1407.

Step S1407 is termination processing. Through the termination, the resources of the cloud service are released until there is an access to the hot folder API again. In the present embodiment, a configuration of using the resources of the cloud service after accessing the hot folder API by using a server-less service has been described. However, the scope of the present disclosure is not limited to this configuration. Needless to mention, the disclosed technique may be realized also in a configuration in which a server is always used.

According to this flowchart, it is possible to perform printing using proper imposition processing based on the cloud-uploaded PDF file and the cloud-uploaded template identifier. Since the processing for forming an image such as imposition processing is performed on the cloud side, even if the user uses a client terminal having low image formation processing capability, it is possible to generate a proper print job.

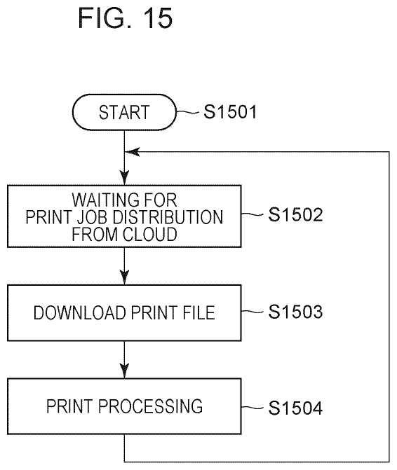

FIG. 15 is a flowchart illustrating a flow of processing regarding the print job transmitting/receiving unit 408 according to the present embodiment.

The processing by the print job transmitting/receiving unit 408 is executed by the CPU 201 of the information processing apparatus 100.

The CPU 201 executes the print job transmission/reception as a background service (1501).

In step S1502, the CPU 201 waits for a transmission of a print job from the cloud service 110. Upon execution of step S1406 at the cloud service 110, a print job is transmitted, and the process proceeds to S1503.

In step S1503, the CPU 201 downloads a PDF file that is to be printed from the cloud service 110. This PDF file is the one generated in step S1406. The CPU 201 downloads the JDF generated in step S1405, too. Upon completion of downloading the necessary data, the process proceeds to step S1504.

In step S1504, the CPU 201 executes print processing by transmitting the PDF file and the JDF downloaded in step S1503 to the image forming apparatus.

Upon execution of the print processing, the CPU 201 returns the process to step S1502 to wait for the next transmission of a print job.

According to this flowchart, the information processing apparatus is capable of downloading the cloud-generated print job and then issues print instructions to the printer. In the example disclosed here, the information processing apparatus 100 acquires a print job from the cloud service 110 and transmits the print job to the image forming apparatus; however, this does not imply any limitation. The cloud service 110 may be configured to transmit the print job to the image forming apparatus directly, not via the information processing apparatus 100.

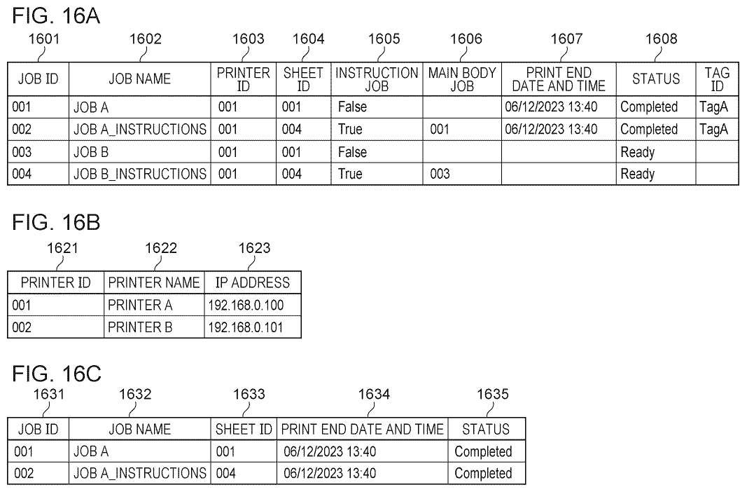

FIG. 16 is a set of diagrams illustrating the structure of a job management table according to the present embodiment. The job management table is a table for managing, by the cloud service 110, the status of print execution at each image forming apparatus by means of a hot folder.

FIG. 16A illustrates an example of information stored in the job storage unit 603. The reference numeral 1601 denotes “job ID” for uniquely identifying a job. The reference numeral 1602 denotes “job name” representing the name of the job. The reference numeral 1603 denotes “transmission destination printer ID” for designating the printer that is to be used for printing the job. The reference numeral 1604 denotes “sheet ID” for designating the sheet that is to be used for printing the job. The reference numeral 1605 denotes “instruction job flag” that shows whether this job is an instruction job or not. The value of the flag is “True” if this job is an instruction job. The value of the flag is “False” if this job is not an instruction job.

The reference numeral 1606 denotes “main body job” that shows, in a case of an instruction job, for which job the instruction is. The cell of the main body job is blank if this job is not an instruction job. If this job is an instruction job, for the purpose of showing for which job the instruction is, the job ID of this job is written in the cell of the main body job. The reference numeral 1607 denotes print end date and time of the job. This cell is blank when printing has not finished yet. The reference numeral 1608 denotes job status. “Ready” is stored in this cell if the job has not been transmitted to the printer yet. “Printing” is stored in this cell if the job is now under printing. “Completed” is stored in this cell if the printing has finished. It is assumed that one job is generated when a file is stored once into one hot folder.

FIG. 16B illustrates an example of information stored in the image forming apparatus information storage unit 604. The reference numeral 1621 denotes “printer ID” for uniquely identifying a printer. The reference numeral 1622 denotes “printer name” representing the name of the printer. The reference numeral 1623 denotes the IP address of the printer. As described above, the cloud service 110 has information on a plurality of image forming apparatuses, and is capable of giving print job execution instructions to the image forming apparatus selected from among them.

FIG. 16C illustrates an example of information stored in the job storage unit 603.

The reference numeral 1631 denotes “job ID” for uniquely identifying a job. The reference numeral 1632 denotes “job name” representing the name of the job. The reference numeral 1633 denotes “sheet ID” for designating the sheet that is to be used for printing the job. The reference numeral 1634 denotes print end date and time of the job. This cell is blank when printing has not finished yet. The reference numeral 1635 denotes job status. “Ready” is stored in this cell if printing has not been performed yet. “Printing” is stored in this cell if printing is currently being performed. “Completed” is stored in this cell if the printing has finished.

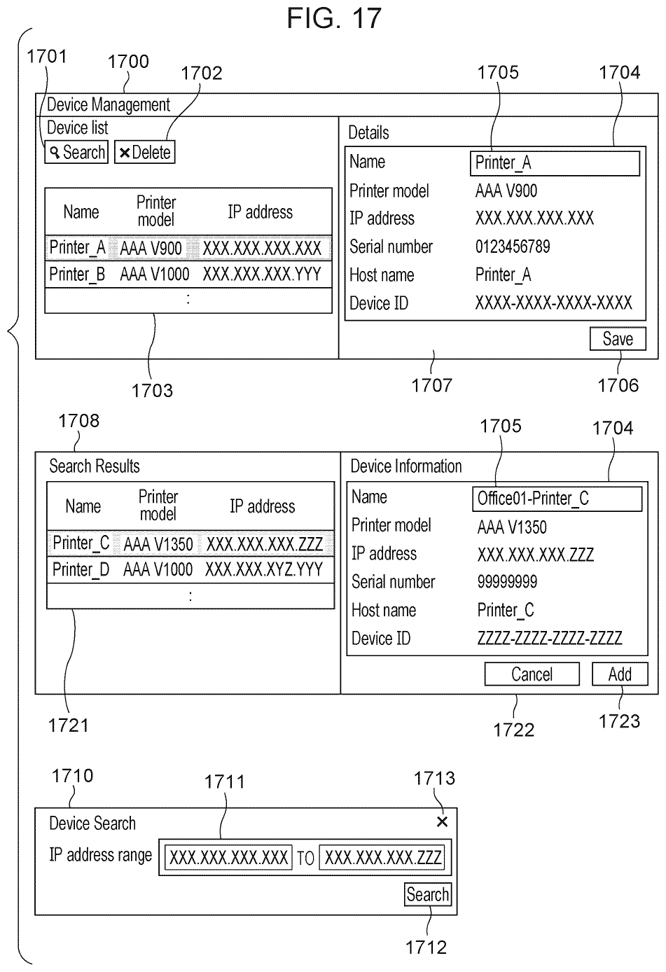

FIG. 17 illustrates a management screen of the image forming apparatus 101 that is provided by the print job transmitting/receiving unit 408 according to the present embodiment. The management screen is displayed on the browser of the information processing apparatus 100. Implementation of each screen illustrated in FIG. 17 does not necessarily have to be exactly in accordance with FIG. 17, and it is sufficient as long as the image forming apparatus 101 can be registered into the cloud service 110. The screen may be displayed using any means other than the browser instead.

The reference numeral 1700 denotes an image forming apparatus management screen. The reference numeral 1701 denotes an image forming apparatus search button. When this button is pressed, an image forming apparatus search screen 1710 opens. The reference numeral 1702 denotes an image forming apparatus deletion button. Processing for deleting the image forming apparatus selected in an image forming apparatus list 1703 from the image forming apparatus information storage unit 604 is executed. The reference numeral 1703 denotes an area for display of a list of image forming apparatuses. A list of image forming apparatuses stored in the image forming apparatus information storage unit 604 is acquired from the image forming apparatus information storage unit 604 and is displayed.

The reference numeral 1704 denotes an image forming apparatus detail setting value display section. The device information on the particular image forming apparatus acquired from the image forming apparatus information storage unit 604 is displayed. In this section, the device information on the image forming apparatus selected in the image forming apparatus list 1703 is displayed.

The reference numeral 1705 denotes an image forming apparatus name input field. The reference numeral 1706 denotes an image forming apparatus name change save button. The name of the image forming apparatus changed in the image forming apparatus name input field 1705 is stored into the image forming apparatus information storage unit 604. The reference numeral 1707 denotes an image forming apparatus information display section, and the host name of the image forming apparatus, the device ID thereof, and the like are displayed here.

The reference numeral 1710 denotes an image forming apparatus search screen. The reference numeral 1711 denotes an IP address input field. The IP address range of the image forming apparatus that is the target of a search is specified here. The reference numeral 1712 denotes an image forming apparatus search start button. When this button is pressed, a search for the image forming apparatus having the IP address designated in the IP address input field 1711 is executed from the local network to which the information processing apparatus 100 is connected. At the same time, the image forming apparatus search screen 1710 closes. The result of the search is displayed on an image forming apparatus search result display screen 1708. The reference numeral 1708 denotes the image forming apparatus search result display screen. The reference numeral 1721 denotes an image forming apparatus search result list. The reference numeral 1722 denotes a cancel button. When this button is pressed, display returns to the initial screen displaying 1701 to 1707. The reference numeral 1723 denotes an image forming apparatus addition button. When this button is pressed, processing of storing the image forming apparatus selected in the image forming apparatus search result list 1721 into the image forming apparatus information storage unit 604 is performed. That is, by transmitting information on the added image forming apparatus to the cloud service 110, the information on the image forming apparatus is registered anew into the cloud service 110.

This screen enables the user to register the information on the image forming apparatus 101 into the cloud service 110 via the user interface of the information processing apparatus 100.

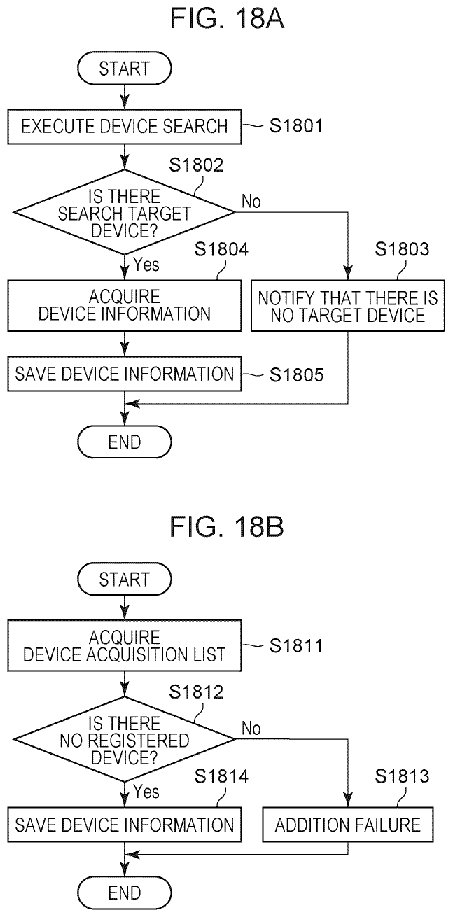

FIG. 18A is a diagram illustrating a flow of image forming apparatus addition at the information processing apparatus 100.

The processing described below is performed by the CPU 201 of the information processing apparatus 100. Implementation of the processing illustrated in FIG. 18A does not necessarily have to be exactly in accordance with FIG. 18A, and it is sufficient as long as an image forming apparatus can be added.

In S1801, the print job transmitting/receiving unit 408 searches for an image forming apparatus from the range of IP addresses inputted by the user in the IP address input field 1711.

In S1802, the print job transmitting/receiving unit 408 determines whether or not there exists the image forming apparatus that is the target of the search. The process proceeds to S1804 if one or more image forming apparatuses exist. The process proceeds to S1803 if not.

In S1803, the print job transmitting/receiving unit 408 displays “No target device exists” on the browser of the information processing apparatus 100 and terminates the processing.

In S1804, the print job transmitting/receiving unit 408 stores information on the image forming apparatus selected by the user from the image forming apparatus search result list 1721 and the name inputted by the user in the image forming apparatus name input field 1705.

In S1805, the print job transmitting/receiving unit 408 transmits a request for registration of the image forming apparatus to the cloud service 110. In this step, the information stored in S1804 is transmitted to the cloud service 110. The result of registration processing from the cloud service 110 is displayed on the browser of the information processing apparatus 100.

Through the processing illustrated in this flowchart, it is possible to register the information on the image forming apparatus 101 into the cloud service 110 from the print job transmitting/receiving unit 408.

FIG. 18B is a diagram illustrating a flow of image forming apparatus addition at the cloud service 110. The processing described below is performed by the CPU 201 of the cloud service 110. Implementation of the processing illustrated in FIG. 18B does not necessarily have to be exactly in accordance with FIG. 18B, and it is sufficient as long as an image forming apparatus can be added.

In S1811, the image forming apparatus management unit 612 receives the request for registration of the image forming apparatus from the information processing apparatus 100.

In S1812, the image forming apparatus management unit 612 analyzes the registration request, and determines whether or not there exists the applicable apparatus by performing a comparison with the image forming apparatus information stored in the image forming apparatus information storage unit 604. The process proceeds to S1814 if the applicable apparatus does not exist. The process proceeds to S1813 if the applicable apparatus exists.

In S1813, the image forming apparatus management unit 612 returns a registration failure response to the information processing apparatus 100. In this step, for example, the user is notified that the image forming apparatus attempted to be registered has already been registered.

In S1814, the image forming apparatus management unit 612 registers the registration-requested image forming apparatus into the image forming apparatus information storage unit 604, returns a registration success response to the information processing apparatus 100, and then terminates the processing. An example of the stored information on the image forming apparatus 101 has already been described with reference to FIG. 16B.

Through the processing illustrated in this flowchart, the cloud service 110 can process the request acquired from the print job transmitting/receiving unit 408 for registration of the image forming apparatus 101, and can register the image forming apparatus 101.

Managing merchandise templates at the cloud service according to the present embodiment makes it possible to use the same template also from an information processing apparatus that is a client connected from a different network.

### Second Embodiment

In a second embodiment, an example will be described in which merchandise template update processing is performed in a case where the merchandise template settings at the cloud service have been changed when the processing of the merchandise template corresponding to the hot folder is executed upon storing of a file into the hot folder. Since the basic configuration of the present embodiment is the same as that of the first embodiment, differences only will be described below.

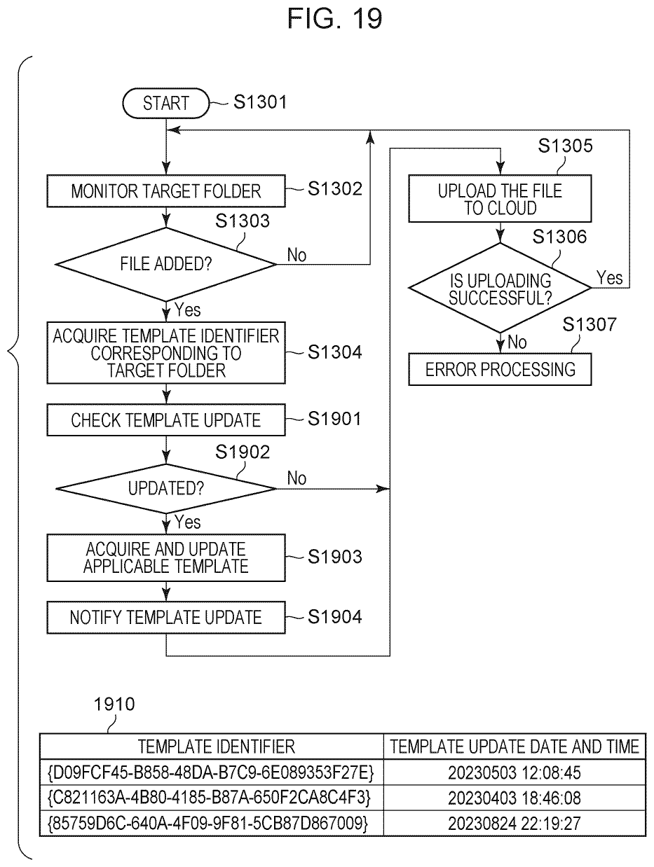

FIG. 19 is a diagram illustrating a flow of merchandise template update processing performed when a file is stored into a hot folder. The basic processing flow is the same as that of FIG. 13, and the processing is performed by the CPU 201 of the information processing apparatus 100. Implementation of the processing illustrated in FIG. 19 does not necessarily have to be exactly in accordance with FIG. 19, and it is sufficient as long as the merchandise template associated with the hot folder can be updated. The same reference numerals are assigned to the same components as those described already, and an explanation of them will be omitted.

In S1901, by using the template identifier acquired in S1304, the hot folder application 400 acquires the update date and time of the merchandise template 1403 that is the target out of a merchandise template update table 1910 from the cloud service 110. The merchandise template update table 1910 is stored in the template storage unit 602, and the update date and time of the merchandise template that is applicable is updated at the timing of the merchandise template creation/updating.

In S1902, the hot folder application 400 determines whether or not the update date and time of the merchandise template of the target acquired from the cloud service 110 is newer than the update date and time of the merchandise template of the target stored in the template storage unit 402. If newer, the process proceeds to S1903. If not, the process proceeds to S1305.

In S1903, the hot folder application 400 acquires the merchandise template 1403 of the target from the cloud service 110 and overwrites it into the template storage unit 402.

In S1904, the hot folder application 400 notifies the user of the updating of the merchandise template of the target.

Through the processing illustrated in this flowchart, it is possible to confirm whether or not the merchandise template that is applicable has been updated, at a timing before uploading print data from the hot folder application 400 to the cloud service 110. Moreover, if updated, it is possible to acquire the merchandise template 1403 from the cloud service 110 and synchronize the merchandise template stored locally therewith.

With the present embodiment, even if the merchandise template has been updated at the cloud service, it is possible to synchronize the merchandise template information of the target that the information processing apparatus has.

### Third Embodiment

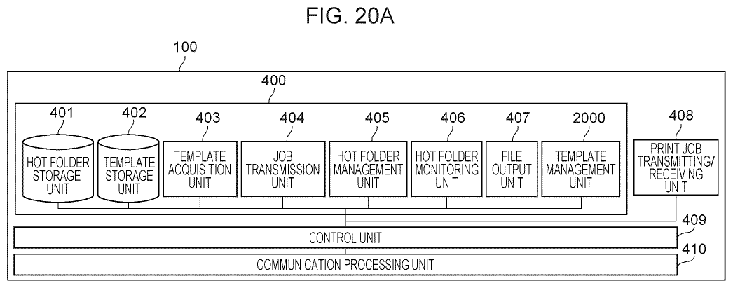

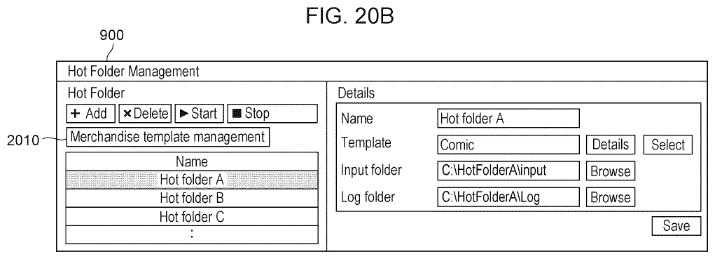

In a third embodiment, with reference to FIG. 20, a configuration of performing merchandise template management by using the cloud service 110 from the hot folder application 400 will be described. Since the basic configuration of the present embodiment is the same as that of the first embodiment, differences only will be described below.

FIG. 20A is a software configuration diagram of the information processing apparatus 100 according to the present embodiment. The same reference numerals are assigned to the same components as those described already, and an explanation of them will be omitted. The configuration illustrated in FIG. 20A is a functional configuration realized by running programs by a computer. Implementation does not necessarily have to be exactly in accordance with FIG. 20A. There are possible variations in configuration: for example, a plurality of functional blocks may be merged, or a part of a certain functional block or a part of some functional blocks in FIG. 20A may be included into another functional block or other functional blocks.

The reference numeral 2000 denotes a template management unit. This unit makes a display request for displaying the merchandise template management screen 800 and a merchandise template creation/updating/deletion request to the template management unit 601 of the cloud service 110.

FIG. 20B illustrates a hot folder management screen provided by the hot folder application 400 according to the present embodiment and displayed on the browser of the information processing apparatus 100. Implementation of the screen illustrated in FIG. 20B does not necessarily have to be exactly in accordance with FIG. 20B, and it is sufficient as long as a merchandise template can be created from the hot folder application 400. This screen may be displayed using any means other than the browser instead. The same reference numerals are assigned to the same components as those described already, and an explanation of them will be omitted.

The reference numeral 2010 denotes a template management button. When this button is pressed, the merchandise template management screen 800 is acquired from the cloud service 110 and displayed.

This screen enables creation and editing of the merchandise template 1403 by using the hot folder application 400 via the user interface of the information processing apparatus 100.

With the present embodiment, it is possible to create a merchandise template by using the merchandise template creation function of the cloud service from the hot folder application that the information processing apparatus has.

### OTHER EMBODIMENTS

In the examples described above, the file stored into the hot folder is processed for printing. However, this does not imply any limitation. For example, the present disclosure can be applied also to a configuration of performing transfer processing of the file stored into the hot folder to another apparatus. In the examples described above, a hot folder configuration has been taken as an example. However, implementation is not limited to a folder configuration. The present disclosure may be applied to any other configuration as long as processing is performed on the basis of settings.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-051064, filed Mar. 27, 2024, which is hereby incorporated by reference herein in its entirety.

What is claimed is:

1. A server system configured to communicate with an information processing apparatus, the server system comprising:
one or more processors; and
one or more memories storing instructions executable by the one or more processors to cause the server system to operate as:
a providing unit configured to provide the information processing apparatus with information for displaying a setting screen on which settings regarding a hot folder are made at the information processing apparatus;
a registering unit configured to, based on an operation received from a user on the setting screen, register information on the hot folder correspondingly together with a setting value associated with the hot folder; and
an acquiring unit configured to acquire capability information on an image processing apparatus that is a target, wherein
the providing unit provides information for displaying a setting screen of printing according to the capability information acquired by the acquiring unit.

2. The server system according to claim 1, further comprising:
an editing unit configured to edit the setting value associated with the hot folder and registered in the registering unit.

3. The server system according to claim 1, wherein
the setting value associated with the hot folder is a setting value group regarding print settings.

4. The server system according to claim 1, wherein
the providing unit further provides information for displaying a preview screen according to a setting value set by the user on the setting screen.

5. The server system according to claim 4, wherein
the providing unit provides information for displaying a selection screen for selecting a file to be used for preview on the preview screen.

6. The server system according to claim 1, wherein
the setting value associated with the hot folder includes a name and a category of the hot folder.

7. The server system according to claim 1, wherein
the setting value associated with the hot folder includes a paper setting, an imposition setting, a color setting, and a number-of-copies setting.

8. The server system according to claim 1, wherein
by an application that runs on the information processing apparatus, the information registered in the registering unit is associated with the hot folder.

9. The server system according to claim 1, wherein
when a file is stored into the hot holder at the information processing apparatus, the file is processed using the setting value associated with the hot folder by the registering unit.

10. A control method executed by a server system configured to communicate with an information processing apparatus, the control method comprising:
providing the information processing apparatus with information for displaying a setting screen on which settings regarding a hot folder are made at the information processing apparatus;
registering, based on an operation received from a user on the setting screen, information on the hot folder correspondingly together with a setting value associated with the hot folder; and
acquiring capability information on an image processing apparatus that is a target, wherein
in the providing, information for displaying a setting screen of printing according to the capability information acquired in the acquiring is provided.

11. A non-transitory computer-readable storage medium storing a program including executable instructions, which when executed by one or more processors of a server system, cause the server system to perform operations comprising:
providing the information processing apparatus with information for displaying a setting screen on which settings regarding a hot folder are made at the information processing apparatus;
registering, based on an operation received from a user on the setting screen, information on the hot folder correspondingly together with a setting value associated with the hot folder; and
acquiring capability information on an image processing apparatus that is a target, wherein
in the providing, information for displaying a setting screen of printing according to the capability information acquired in the acquiring is provided.
